(19) United States
(12) Patent Application Publication
(10) Pub. No.: US 2024/0245994 A1
(43) Pub. Date: Jul. 25, 2024

(54) STORAGE MEDIUM, GAME SYSTEM USED IN SAME, AND CONTROL METHOD

(71) Applicant: KONAMI DIGITAL ENTERTAINMENT CO., LTD., Tokyo (JP)

(72) Inventors: Masaki NAKAMURA, Tokyo (JP); Shin TSUCHIYA, Tokyo (JP); Masatoshi OJIMA, Tokyo (JP); Shintaro KUMAKAWA, Tokyo (JP); Shota KOBAYASHI, Tokyo (JP); Akira YAMASHITA, Tokyo (JP)

(73) Assignee: KONAMI DIGITAL ENTERTAINMENT CO., LTD., Tokyo (JP)

(21) Appl. No.: 18/626,510

(22) Filed: Apr. 4, 2024

Related U.S. Application Data
(63) Continuation of application No. PCT/JP22/36792, filed on Sep. 30, 2022.

(30) Foreign Application Priority Data
Oct. 14, 2021 (JP) 2021-168530

(51) Int. Cl. A63F 13/56; A63F 13/812

(52) U.S. Cl. CPC A63F 13/56; A63F 13/812

(57) ABSTRACT

A non-transitory computer readable storage medium according to the present invention stores a computer program causing a control unit of a game device to function as the following devices, the game device providing a soccer game that causes a player on the defense side to execute a charge action under automatic control when a continuous pressing operation is executed on an L2 button of a controller. Namely, the computer program causes the control unit to function as a device that, when an operation is inputted after the hand of the player on the defense side reaches a player on the offense side during the charge action, acquires the result of the operation, and if the operation is an operation on an L stick, causes the player on the defense side to execute an opponent moving action that moves the player on the offense side in the operation direction of the operation, so that the operation is reflected in the charge action.

### BACKGROUND OF THE INVENTION

### Field of the Invention

The present invention relates to a computer program and so on, applied to a computer incorporated in a game system connected to a display device that displays a game screen including an offense character and a defense character which play roles of offense and defense respectively, and an input device that inputs a plurality of operations executed by a user as operations for operating the defense character in the game screen, and providing a game in which the defense character is automatically caused to execute a predetermined defense action according to a predetermined rule when a specific operation out of the plurality of operations is executed.

### Description of the Related Art

There is a game system connected to a display device that displays a game screen including an offense character and a defense character which play roles of offense and defense respectively, and an input device that inputs a plurality of operations executed by a user as operations for operating the defense character in the game screen, and the game system providing a game in which the defense character is automatically caused to execute a predetermined defense action according to a predetermined rule when a specific operation out of the plurality of operations is executed. For example, a computer program that causes a computer of a game system to provide a soccer game including a plurality of players functioning as an offense character and a defense character is known (refer to, for example, Patent Literature 1).

### CITATION LIST

### Patent Literature

Patent Literature 1: JP3145064B

### SUMMARY OF THE INVENTION

### Technical Problem

In a soccer game in Patent Literature 1, when an operation of indicating a tackle is executed, a tackle action is executed by automatic control on a character on a defense side according to a positional relationship between two characters corresponding to offense and defense, respectively. The character on the defense side moves by the automatic control for the tackle action, and a motion destination (tackle destination) is automatically set according to the positional relationship. In this case, it is possible to ensure a certain level of accuracy or more from a beginner to an expert as accuracy (effect) of the tackle action. However, on the other hand, there is little room for a skill of a user to be reflected.

Therefore, an object of the present invention is to provide a computer program and so on, that can increase the room for a difference in skill between users to be reflected in a defense action of the automatic control.

### Solution to Problem

The non-transitory computer readable storage medium of the present invention is a non-transitory computer readable storage medium storing a computer program for a computer incorporated in a game system connected to a display device that displays a game screen including an offense character and a defense character which play roles of offense and defense respectively, and an input device that inputs a plurality of operations executed by a user as operations for operating the defense character in the game screen, and providing a game in which the defense character is automatically caused to execute a predetermined defense action according to a predetermined rule when a specific operation out of the plurality of operations is executed, wherein the computer program causes the computer to function as: a result acquisition unit that acquires, when an input of an operation out of the plurality of operations is executed through the input device after a special condition related to a position between the defense character and the offense character is satisfied during the defense action, a result of the input; and an action control unit that causes the defense character to execute an additional action so that the additional operation is reflected in an action of the defense character when the operation is determined to be an additional operation associated with the additional action that can be added to the defense action based on the result of the input.

The game system according to the present invention is a game system comprising a computer connected to a display device that displays a game screen including an offense character and a defense character which play roles of offense and defense respectively, and an input device that inputs a plurality of operations executed by a user as operations to for operating the defense character in the game screen, and providing a game in which the defense character is automatically caused to execute a predetermined defense action according to a predetermined rule when a specific operation out of the plurality of operations is executed, wherein the computer serves as: a result acquisition unit that acquires, when an input of an operation out of the plurality of operations is executed through the input device after a special condition related to a position between the defense character and the offense character is satisfied during the defense action, a result of the input; and an action control unit that causes the defense character to execute an additional action so that the additional operation is reflected in an action of the defense character when the operation is determined to be an additional operation associated with the additional action that can be added to the defense action based on the result of the input.

The control method according to the present invention is a control method executed by a computer incorporated in a game system connected to a display device that displays a game screen including an offense character and a defense character which play roles of offense and defense respectively, and an input device that inputs a plurality of operations executed by a user as operations for operating the defense character in the game screen, and providing a game in which the defense character is automatically caused to execute a predetermined defense action according to a predetermined rule when a specific operation out of the plurality of operations is executed, wherein the control method comprises: a result acquisition procedure of acquiring, when an input of an operation out of the plurality of operations is executed through the input device after a special condition related to a position between the defense character and the offense character is satisfied during the defense action, a result of the input, and an action control procedure of causing the defense character to execute an additional action so that the additional operation is reflected in an action of the defense character when the operation is determined to be an additional operation associated with the additional action that can be added to the defense action based on the result of the input.

### BRIEF DESCRIPTION OF THE DRAWINGS

FIG. 1 is a diagram illustrating an example of an overall configuration of a game system according to an embodiment of the present invention.

FIG. 2 is a diagram illustrating an example of a specific configuration of a controller.

FIG. 3 is a diagram schematically illustrating an example of an entire screen.

FIG. 4 is an explanatory diagram for describing an example of a charge action.

FIG. 5 is an explanatory diagram for describing an example of a relationship between an additional operation and an opponent moving action.

FIG. 6 is a functional block diagram illustrating a substantial part of a control system of a game device.

FIG. 7 is a flowchart illustrating an example of a procedure of charge processing.

FIG. 8 is a flowchart illustrating an example of a procedure of player moving processing.

FIG. 9 is an explanatory diagram for describing an example of an additional operation when a mobile phone is used as a game device.

FIG. 10 is an explanatory diagram for describing an example of an additional operation when a portable game machine is used as a game device.

### DESCRIPTION OF THE EMBODIMENTS

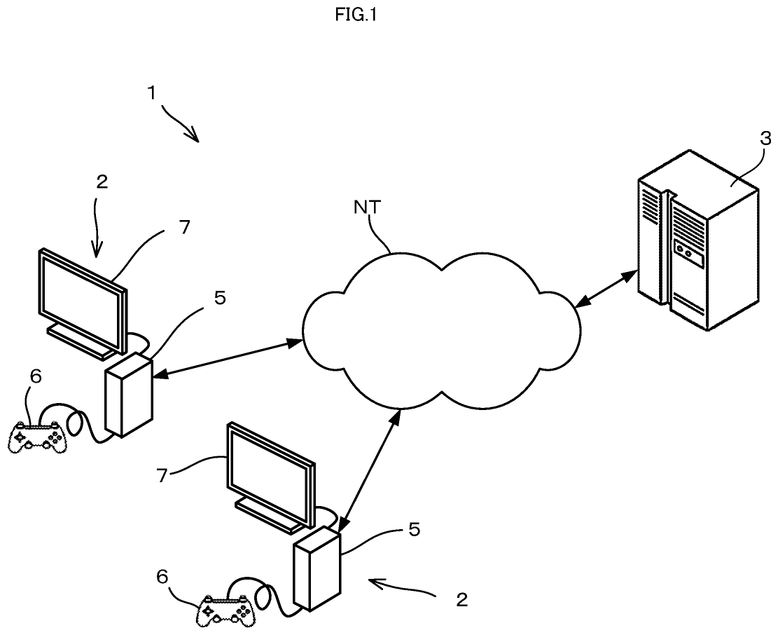

Hereinafter, a game system according to an embodiment of the present invention is described. FIG. 1 illustrates an example of an overall configuration of a game system 1 according to an embodiment of the present invention. The game system 1 is formed as a client/server system including a plurality of game devices 2 as clients and a server 3 connected to the game devices 2 via a network NT (for example, the Internet).

The game device 2 is a device used for play of a game by a user, and is a type of an information communication terminal device having an information communication function via the network NT. As the game device 2, an appropriate computer device that provides a game may be used. For example, a commercial game device (often installed in a predetermined facility) that causes a user to play a game in exchange for payment of a predetermined play fee within a range corresponding to the play fee may be used as the game device 2, but in the example in FIG. 1, a user terminal device is used as the game device 2.

The user terminal device is a computer device that can be connected to a network and is used for personal use of the user. For example, such a computer device includes a mobile terminal device such as a stationary or book type personal computer, a mobile phone (including a smartphone), a portable game machine, or a portable tablet terminal device. Such various computer devices may be appropriately used as the game device 2, and in the example in FIG. 1, a stationary home game machine is used. Such a game device 2 may be appropriately formed, and includes, as an example, a stationary game machine main body 5, a controller 6 as an example of an input device connected to the game machine main body 5, and a monitor 7 as an example of an output device.

The game machine main body 5 is formed mainly for the purpose of providing a game, and is sometimes referred to as a consumer game machine or a game console. The input device is not limited to the controller 6, and may be an appropriate input device for inputting various types of play action (indications or operations), such as a camera for inputting an motion as play action (various indications) of the user, or a touch panel for outputting a signal according to a touch position, for example. The output device may include a speaker unit, for example, for audio output in addition to the monitor 7, but the illustration thereof is omitted. A plurality of monitors 7 may be connected to the game machine main body 5.

The server 3 may be formed by appropriately combining a plurality of server units, or may be formed of a single server unit. The server 3 may be formed as a cloud server using a cloud computing technology. The server 3 provides the game device 2 with various services related to a game such as, for example, a service for matching players who should match in the game, and a service for relaying game information that should be shared between the game devices 2. Incidentally, various information communication terminal devices such as a mobile phone, a smartphone, and a game machine for business use may be appropriately added to the game system 1. For example, the game machine for business use may be used as a client that provides a game in cooperation with the game provided by the game device 2.

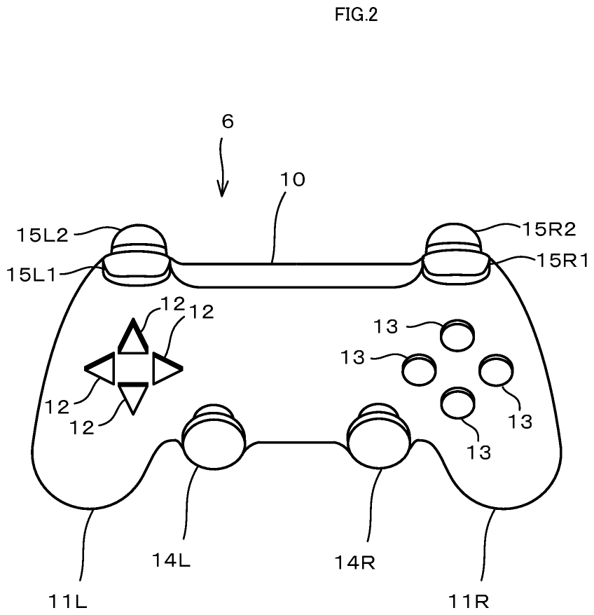

FIG. 2 illustrates an example of a specific configuration of the controller 6. The controller 6 includes a main body housing 10 a shape and a size of which are selected on the assumption that the user holds the main body housing 10 with both hands. The main body housing 10 includes grips 11L and 11R for gripping the main body housing 10 with left and right hands. Four direction keys 12 are provided in a front upper portion of the grip 11L on a left side, four operation buttons 13 are provided in a front upper portion of the grip 11R on a right side, and a pair of sticks 14L and 14R is provided between the grips 11L and 11R. The sticks 14L and 14R can be operated in all directions, that is, in any direction of 360° from a neutral position as the position in a non-operation state. Furthermore, two operation buttons 15L1 and 15L2 are provided on an upper end face of the grip 11L on the left side, and two operation buttons 15R1 and 15R2 are provided on an upper end face of the grip 11R on the right side. Hereinafter, there is a case where the stick 14L on the left side is referred to as an L stick 14L, the stick 14R on the right side is referred to as an R stick 14R, the operation buttons 15L1 and 15L2 on the left side are referred to as an L1 button 15L1 and an L2 button 15L2 in order from the front side of the controller 6, and the operation buttons 15R1 and 15R2 on the right side are referred to as an R1 button 15R1 and an R2 button 15R2 in order from the front side of the controller 6 for distinction. In contrast, there is also a case where the stick 14L and 14R are collectively referred to as the stick 14, and the operation buttons 15L1, 15L2, 15R1, and 15R2 are collectively referred to as the operation button 15.

Each of the direction key 12, the operation button 13, the stick 14, and the operation button 15 of the controller 6 functions as an example of an operation unit of the input device. A plurality of types of operations (a plurality of operations) is appropriately input to the controller 6 via the operation units. Among the operation units, at least a part of operation units is provided as an operation amount detection type operation unit in which an operation amount by the user is to be detected and an output signal changes according to the operation amount. For example, the stick 14 and the operation button 15 are provided as the operation units of the type. Therefore, regarding the operation of the stick 14, an operation direction and an operation amount (angle of inclination from the neutral position) thereof are detected and reflected in the output signal. Regarding the operation of the operation button 15, a push-in operation amount thereof is detected and reflected in the output signal. In contrast, the direction key 12 and the operation button 13 are both provided as on/off type operation units in which presence or absence of a push-in operation is to be detected and the presence or absence of the operation is reflected in the output signal. Note that, the distinction is an example, and can be appropriately set. The operation amount detection type operation unit may also be switchable on software so as to function as the on/off type operation unit in which only the presence or absence of the operation is to be detected, for example, according to a setting of the user.

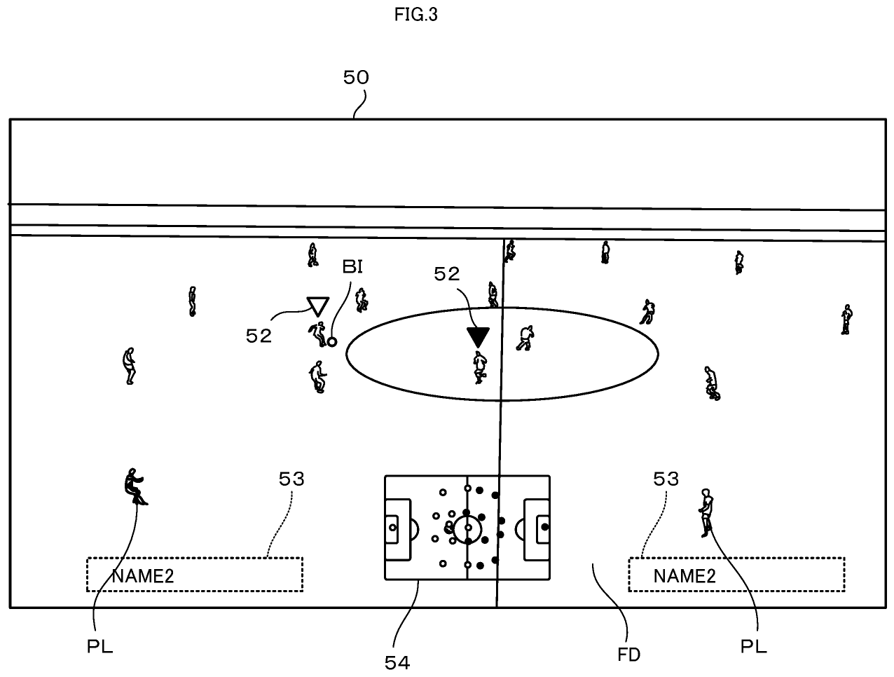

Next, the game provided via the game device 2 is described with reference to FIG. 3. In the game system 1 of this embodiment, a match type soccer game in which the user of the game device 2 matches against a user of an opponent through soccer is provided. The opponent may be a real user who uses any one of the game devices 2 or may be a virtual presence controlled by the game device 2 or a computer of the server 3. The match does not necessarily need to be one-to-one. For example, soccer may be played in a form of a so-called group match in which a group including at least one user matches against another group.

FIG. 3 is a diagram schematically illustrating an example of an entire screen. In the soccer game, various game screens can be appropriately used, and an entire screen 50 is a game screen for displaying an entire field of the soccer game. Specifically, in the soccer game, a viewpoint is automatically switched to an optimum position according to a situation of the match and the game screen according to the viewpoint can be displayed on the monitor 7; the entire screen 50 is observed from a predetermined viewpoint from which a state of the entire field can be seen. In this case, as illustrated in FIG. 3, the entire screen 50 includes a player (reference sign is assigned only to a part of the players) PL, a ball BI, and a field FD.

Both the player PL and the ball BI are examples of objects that act in a virtual space of the game, and the player PL corresponds to each player forming a soccer team. Each team includes a plurality of players PL, and a user team associated with the user and an opponent team associated with the opponent are formed. Therefore, the soccer game is configured as a team match-type game in which the user team and the opponent team match against each other.

In contrast, the ball BI is an object corresponding to a ball in soccer, and functions as a target for which offending and defending teams compete. The ball BI is operated to move, for example, according to the action of the player PL. Then, in the soccer game, offense and defense are switched between the two teams according to presence or absence of the player who operates the ball BI. The field FD is a region corresponding to a field (pitch) of soccer, and is a main activity range of the player PL. The field FD is divided by various lines such as a touch line or a goal line. The player PL might act outside the lines, but often uses the field FD as the activity range. Then, as is well known, in the soccer game, the match progresses as each player PL of the user and the opponent behaves as in actual soccer in the virtual field FD.

A part of the players in the field FD is set as the player PL to be operated by the user. One player PL is selected as the operation target for one user. For example, when the user is on an offense side, the player PL who should control the ball BI is set as the operation target of the user, and for the user on a defense side, the player PL who should take charge of defense with respect to the player PL who controls (operates) the ball BI is set as the operation target. The player PL to be operated is appropriately switched according to the operation (indication to change a target) of the user. The operation of the player PL to be operated may include various operations on an appropriate operation unit, and includes an operation by the L stick 14L as an example. Specifically, the player PL to be operated moves in a direction in which the L stick 14L is operated in the entire screen 50. In the entire screen 50, the player PL to be operated can be identified by, for example, a cursor 52.

The cursor 52 maybe displayed only on the player PL who is currently operated; but as an example, the cursor 52 is displayed on the player PL who is currently operated and the player PL who is scheduled to be changed to the operation target next according to the indication to change the target. Although the cursors 52 may be identified as appropriate, in the example in FIG. 3, the cursor 52 of the player PL who is currently operated is displayed in white, and the cursor 52 indicating the player PL scheduled to be changed to the operation target next is displayed in black. That is, the cursors 52 are displayed so as to be identifiable from each other by a difference in color. An information portion 53 indicating a name, for example, of the player PL to be operated may be added to the entire screen 50. The action of the player PL to be operated is controlled based on the operation of the user on the controller 6. In contrast, the action of the player PL who is not to be operated is automatically controlled according to the situation of the game.

The entire screen 50 may also additionally include various objects or information as appropriate, and includes a map 54 in the example in FIG. 3. The map 54 is an image (information) indicating a position of the player PL in the entire field FD. The map 54 maybe disposed at an appropriate position in the entire screen 50, and is disposed at the center of a lower portion in the example in FIG. 3. Furthermore, information indicating the situation of the match such as team names of the user and the opponent, scores, and elapsed time may be displayed at appropriate positions in the entire screen 50.

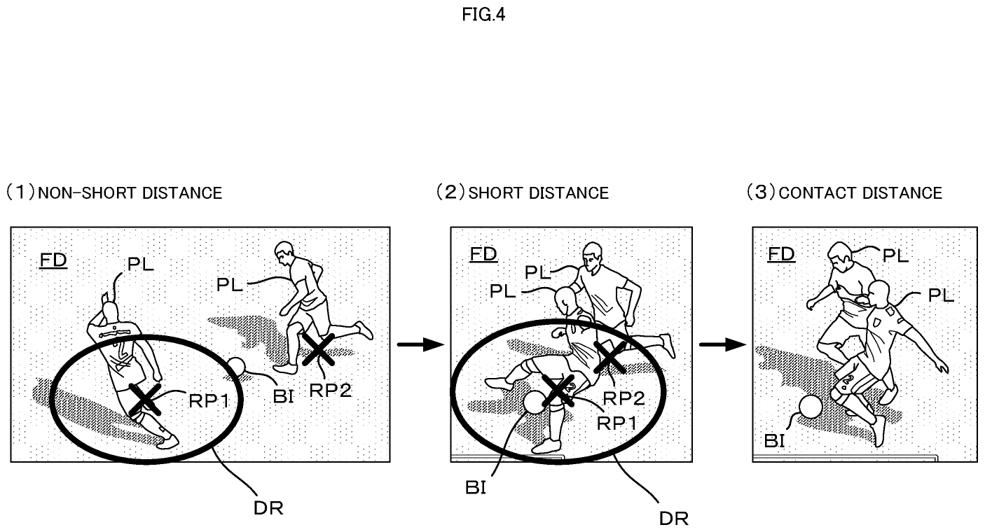

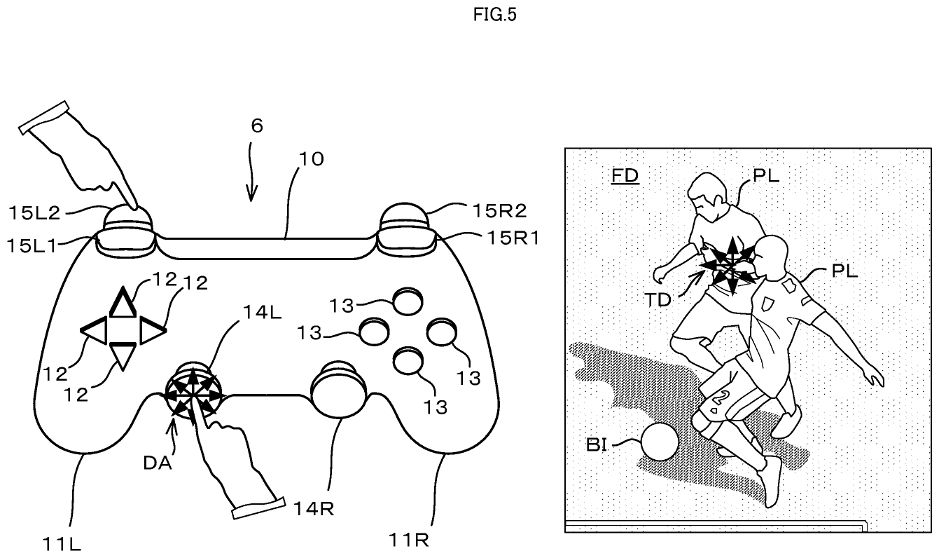

Next, a charge action executed by the player PL on the defense side is described with reference to FIGS. 4 to 5. As described above, the player PL to be operated basically acts to move according to the operation of the user on the L stick 14L (hereinafter, the action of moving according to the operation on the L stick 14L in the entire screen 50 is sometimes referred to as a manual action), but various automatic actions in which each player PL is controlled to automatically act according to a predetermined rule are also prepared in the soccer game. Such an automatic action includes a defense action and an offense action, and the charge action is one of the defense automatic actions. The charge action is an action corresponding to charge in actual soccer. Charge in actual soccer is behavior for the player on the defense side to take a ball from the player on the offense side, and often involves behavior of moving the position of the player on the offense side by putting a shoulder, for example, on the player on the offense side to insert the body of the player on the defense side between the player on the offense side and the ball. The charge action is formed to be able to include a similar action (behavior).

FIG. 4 is an explanatory diagram for describing an example of the charge action. The charge action may be formed as an appropriate action for taking the ball BI, and the example in FIG. 4 illustrates a case where an action of cutting in between the player PL on the offense side and the ball BI operated by the player PL to take the ball BI is executed as the charge action. The automatic action is executed based on a specific operation out of a plurality of operations that might be input through various operation units provided on the controller 6 such as the stick 14 and the operation button 15; and as an example, an operation of pressing the L2 button 15L2 is assigned to (associated with) the charge action as such a specific operation. More specifically, when a continuous pressing operation (continuously pressing operation) is executed on the L2 button 15L2, the action of the player PL on the defense side is switched from the manual action based on the operation of the user to the charge action (automatic action). That is, when the operation of continuously pressing the L2 button 15L2 (specific operation) is executed, the player PL on the defense side executes the charge action by automatic control. Then, as long as the pressing operation is continued, the charge action is continuously executed. Such an operation of pressing the L2 button 15L2 can be executed at an appropriate time, and the example in FIG. 4 illustrates a case executed when the player PL on the defense side is located at a position away from the player PL on the offense side by a certain distance. The example in FIG. 4 schematically illustrates the player PL on the offense side and the player PL on the defense side in such a case in an enlarged manner.

As illustrated in FIG. 4, the position of the player PL on the defense side includes three positions at (1) a non-short distance, (2) a short distance, and (3) a contact distance according to a positional relationship with the player PL on the offense side, and different actions are sequentially executed as a part of the charge action in each of them. Incidentally, the player PL on the offense side and the player PL on the defense side in the example in FIG. 4 maybe displayed through the game screen, for example, for the charge action different from the entire screen 50, but are displayed in the entire screen 50 as an example. In the example, the player PL on the defense side and the player PL on the offense side (the side that controls the ball BI) function as a defense character and an offense character (both are human-shaped characters) of the present invention, respectively. The charge action functions as a defense action of the present invention.

The non-short distance corresponds to a case where the player PL on the defense side is away from the player PL on the offense side by more than a certain distance. The position of the player PL on the defense side and the position of the player PL on the offense side may be specified as appropriate, and are specified based on a first reference position RP1 and a second reference position RP2 as illustrated in (1) in FIG. 4 as an example. That is, it is determined as the non-short distance when the player PL on the defense side is located at the first reference position RP1 and the player PL on the offense side is located at the second reference position RP2. The first reference position RP1 and the second reference position RP2 may be appropriately set based on a body shape of each player PL and so on, and as an example, both are set to positions obtained by projecting a barycentric position of the player PL onto the field FD from above in a vertical direction in the entire screen 50 (virtual three-dimensional space). A circular determination range DR indicating a certain distance around the first reference position RP1 (the position of the player PL on the defense side) is set for the player PL on the defense side. A radius (certain distance) of the determination range DR may be appropriately set, and is set to a distance corresponding to 2 meters in the field FD (virtual three-dimensional space) as an example. Then, when the second reference position RP2 (the position of the player PL on the offense side) is located (included in) outside the determination range DR (certain distance), the position of the player PL on the defense side corresponds to the non-short distance.

In order to cut in between the player PL on the offense side and the ball BI, it is necessary to be near the player PL on the offense side (or the ball BI). Therefore, at the non-short distance, first, as the charge action, an action of approaching the player PL on the offense side is executed so that the distance between the first reference position RP1 and the second reference position RP2 decreases. The approaching action is an action of moving toward the player PL on the offense side in order to decrease the distance, and is executed so as to move toward a predetermined position in consideration of progress of the player PL on the offense side instead of the current position (second reference position RP2). That is, when the continuous pressing operation (continuously pressing operation) is executed on the L2 button 15L2 as described above, the manual action is switched to the charge action (automatic action), and the charge action is started; and the player PL on the defense side first executes the approaching action as the charge action. Incidentally, the approaching action in the charge action may be appropriately omitted, when the distance between the player PL on the defense side and the player PL on the offense side is within a certain distance (within a distance determined to be sufficiently close), for example.

The short distance corresponds to a case where the player PL on the defense side is located within the certain distance from the player PL on the offense side, that is, a case where the second reference position RP2 (the position of the player PL on the offense side) is located inside the determination range DR. In the short distance, various actions for taking the ball BI may be appropriately executed as a part of the charge action, and in the example in FIG. 4, an action of extending a hand toward the player PL on the offense side is executed as a preliminary action of the action executed at the contact distance. When the preliminary action is not necessary for the action at the contact distance, such as when the action of hitting the shoulder against the player PL on the offense side is executed at the contact distance, or even when the preliminary action is necessary, the action of extending the hand may be appropriately omitted according to the convenience of display, for example, but this is executed as an example. Specifically, when the second reference position RP2 (the position of the player PL on the offense side) is located (included) inside the determination range DR, that is, when the player PL on the offense side is located within 2 meters, the player PL on the defense side starts extending the hand toward the player PL on the offense side as the preliminary action.

The contact distance corresponds to a case where the player PL on the offense side is located in a range in which the player PL on the defense side can reach with hand (hand is in contact). The contact distance may be appropriately set according to a type of the preliminary action at the short distance, for example, and when the action of extending the hand is executed as the preliminary action, as an example, the contact distance is set to a range in which the player PL on the defense side can reach with hand. The range can be commonly set for all the players PL in a uniform range (distance) set as the range in which the hand reaches; but as an example, a parameter regarding a length of an arm is set for each player PL, and the range is set according to the parameter. Incidentally, for convenience of description, the determination range DR, the first reference position RP1, and the second reference position RP2 are displayed in (1) and (2) in the example in FIG. 4, but the displays are omitted in the actual entire screen 50 as illustrated in (3) of the example in FIG. 4.

At the contact distance, an action of actively cutting in between the player PL on the offense side and the ball BI in order to take the ball BI is executed as a part of the charge action. In order to cut in between the player PL on the offense side and the ball BI, there is also a case where positioning superior to that of the player PL on the offense side is required in the positional relationship with the ball BI. Therefore, at the contact distance, there is a case where an opponent moving action for moving the position of the player PL on the offense side in a predetermined direction is additionally executed as a part of the cutting-in action. The opponent moving action is an action that is allowed at the contact distance and can be added to the cutting-in action based on the operation of the user. As the opponent moving action, various actions for moving (changing the position of) the opponent, such as the action of hitting the shoulder (so-called shoulder charge) may be appropriately executed, and for example, an action of moving the opponent using the hand that reaches (conceptually contacts) the player PL on the offense side is executed. As an example, the charge action includes the approaching action, the action of extending the hand, and the cutting-in action in this manner, and the actions are sequentially executed as the charge action according to the distance to the player PL on the offense side.

The opponent moving action is further described in detail with reference to FIG. 5. The opponent moving action is allowed when a special condition related to a position between the player PL on the defense side and the player PL on the offense side is satisfied. As such a special condition, various conditions such as a simple positional relationship between the player PL on the offense side and the player PL on the defense side, random, or a game situation may be used, and as an example, a condition satisfied when the hand of the player PL on the defense side reaches the player PL on the offense side by the action of extending the hand is used. That is, the special condition is satisfied at the contact distance, and as a result, the opponent moving action is allowed at the contact distance as described above. It may also be appropriately determined whether the opponent moving action is additionally executed at the contact distance according to various conditions such as the positional relationship between the player PL on the offense side and the player PL on the defense side, random, or the game situation, and it is determined based on presence or absence of the additional operation associated with the opponent moving action as an example. That is, when the additional operation is further executed at the contact distance, the opponent moving action is actually executed as a part of the charge action. FIG. 5 is an explanatory diagram for describing an example of a relationship between the additional operation and the opponent moving action in such a case. Specifically, the example in FIG. 5 includes a portion obtained by enlarging the player PL on the offense side (player on a far side in the drawing) and the player PL on the defense side (player on a near side in the drawing) at the contact distance of the example in FIG. 4, and a portion indicating the controller 6 when the additional operation corresponding to the opponent moving action that might be executed there is indicated.

As illustrated in FIG. 5, the additional operation may be appropriately implemented through various operation units provided on the controller 6, and may be implemented by, for example, an operation of pressing the operation button 13 associated with a specific action such as pressing or pulling, and is implemented by an operation on the L stick 14L as an example. Specifically, the operation direction of the L stick 14L functions as an indication of a direction in which the player PL on the offense side is moved. That is, the operation direction of the L stick 14L functions as a predetermined direction in which the player PL on the offense side is moved, and the player PL on the defense side executes the opponent moving action so as to move the player PL on the offense side in the operation direction when the L stick 14L is operated while the operation of pressing on the L2 button 15L2 is continued at the contact distance (during the indication of the charge action). In the example, the opponent moving action functions as an additional action and a moving action of the present invention.

The operation in the operation direction in all directions (360 degrees) may be executed on the L stick 14L, and in the example in FIG. 5, direction arrows DA indicating eight directions (front and back, left and right, diagonally forward right, diagonally backward right, diagonally forward left, and diagonally backward left) out of the operation directions are illustrated. When the operation in the operation direction corresponding to the eight directions is executed on the L stick 14L, the opponent moving action is executed so that the operation direction is reflected in a moving direction TD in which the player PL on the offense side is moved. That is, various operations can be input to the controller 6 also while the operation of pressing on the L2 button 15L2 is continued (during the indication of the charge action), but when the operation corresponds to the operation on the L stick 14L, the operation is reflected in the opponent moving action in the charge action. As a result, eight directions corresponding to the operation directions on the L stick 14L also occur in the moving direction TD of the opponent moving action.

Specifically, when the right hand of the player PL on the defense side reaches the player PL on the offense side at the contact distance, but the operation direction of the operation on the L stick 14L is diagonally forward left, the player PL on the defense side executes the opponent moving action so as to move (push) the player PL on the offense side diagonally forward left through the right hand. That is, with the operation diagonally forward left, the opponent moving action in which the moving direction TD is diagonally forward left occurs. Such an opponent moving action may occur so that a relative distance between the player PL on the defense side and the player PL on the offense side is maintained, but this occurs so that the relative distance is changed as an example. The same applies to the front and back directions, left direction, diagonally forward right direction, diagonally backward right direction, diagonally forward left direction, and diagonally backward right direction. That is, the operation of the L stick 14L is associated with the moving direction TD through the operation direction, and for example, the operation in the eight directions corresponds to the opponent moving action in similar eight directions. In the example, the operation of the L stick 14L in the eight directions functions as two or more additional operations and a plurality of direction indication operations of the present invention. The opponent moving action in the eight directions associated with them functions as two or more additional actions of the present invention.

For example, in a case of the opponent moving action in the diagonally forward left direction, an effect that the player PL on the offense side loses balance is expected. As a result, a distance for cutting in between the ball BI and the player PL on the offense side by body increases, and an increase in possibility of taking the ball BI (cutting in between the ball BI and the player PL on the offense side by body) is also expected. Alternatively, when the operation in the diagonally backward right direction on the L stick 14L is executed, the player PL on the defense side executes the opponent moving action of moving (pulling) the player PL on the offense side in the diagonally backward right direction through the right hand, and in this case, the player PL on the offense side is brought closer to the player on the defense side. Note that, depending on the timing, it may be possible to achieve an effect of losing balance, or it may be possible to reduce a speed of dribbling. In contrast, when the opponent moving action occurs so as to bring the ball BI closer to the player PL on the offense side away from the ball BI, there is a possibility that dribbling, for example, is assisted and the holding of the ball BI is assisted. That is, the opponent moving action does not necessarily work in an advantageous manner for taking the ball BI. In any case, since the play (for example, dribbling) of the player PL on the offense side is affected, a possibility of taking the ball BI might change.

In contrast, although a penalty for the opponent moving action may not be provided, the penalty is provided according to the actual soccer game as an example. For example, in the actual soccer game, a foul is given to behavior of hitting the opponent from behind or excessively pushing or pulling the opponent. Therefore, a similar penalty is set for the opponent moving action. Specifically, when the opponent moving action is executed from behind the player PL on the offense side, a foul is given to the opponent moving action as in the actual soccer game. As an example, a content of the additional operation is reflected in the opponent moving action in this manner. As a result, an operation result of the user is reflected in the charge operation, and a difference according to a user's skill may also occur in the result of the charge action (automatic action).

Incidentally, foul determination is not uniformly applied to the opponent moving action from behind, and it is possible to take into consideration whether an advantageous development occurs with the opponent moving action as in the case of the actual soccer game. Specifically, the foul determination may be applied only when the opponent moving action works against the player PL on the offense side, and this may be not applied when the opponent moving action is not necessarily disadvantageous (for example, when it is determined that the ball BI can be kept according to the distance to the ball BI, the moving speed of both, the moving direction, or the like).

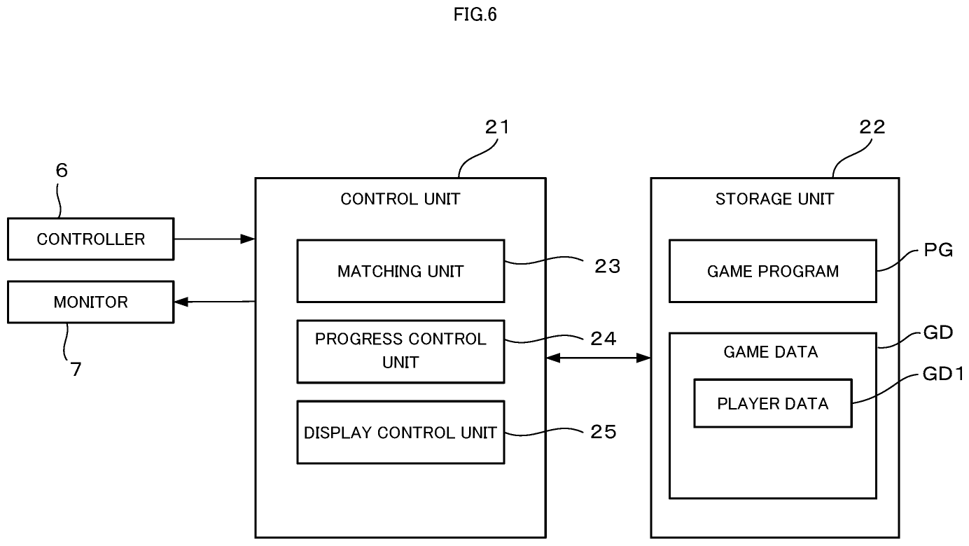

Next, a substantial part of a control system of the game device 2 is described with reference to FIG. 6. The game device 2 is provided with a control unit 21 as a computer and a storage unit 22 as a storage device. The control unit 21 is formed as a computer in which a CPU as an example of a processor that executes various pieces of processing according to a predetermined computer program, and an internal memory necessary for an operation thereof and other peripheral devices are combined. The control unit 21 is provided with various logical devices implemented by a combination of hardware resources of the control unit 21 and a game program PG as software resources; in an example in FIG. 6, a matching unit 23, a progress control unit 24, and a display control unit 25 are illustrated.

The matching unit 23 is a logical device that executes various pieces of processing related to matching between the user and the opponent. For example, when the user matches against another user (opponent) who plays the soccer game using another game device 2, matching via the server 3 is required; the matching unit 23 executes various pieces of known processing related to the matching.

The progress control unit 24 is a logical device that executes various pieces of processing for controlling the progress of the game. Such pieces of processing include processing of appropriately switching various game screens for playing the soccer game, measuring various types of time, or executing determination of various rules (including penalties such as foul), for example.

The display control unit 25 is a logical device that executes various pieces of processing for controlling the display of various objects included in the game screen. Such pieces of processing include, for example, processing of causing the player PL to be operated by the user to execute an action according to the operation result of the user in the entire screen 50, and processing of acquiring an operation result of the opponent via the server 3 and causing the player PL to be operated by the opponent to execute an action based on the operation result. For example, the processing executed by the display control unit 25 includes processing of executing display of various motions of the ball BI corresponding to shoot, and the like, and causing the player PL to act to execute shoot, and the like. The processing executed by the display control unit 25 also includes processing for implementing the charge action. The display control unit 25 executes charge processing and player moving processing as an example of such processing. The procedure of the charge processing and the player moving processing is described later in detail.

The storage unit 22 is an external storage device implemented by a storage unit including a non-volatile storage medium (computer-readable storage medium) such as a hard disk and a semiconductor storage device. Various data are recorded in the storage unit 22 together with the game program PG described above, and game data GD is illustrated in the example in FIG. 6. The game data GD is data for causing the user to play the soccer game according to the game program PG. The game data GD may include various data such as image data for displaying various images for the soccer game and BGM data for reproducing various BGMs, for example; in the example in FIG. 6, player data GD1 is illustrated.

The player data GD1 is data for defining various characters included in the soccer game. Such a character includes the player PL, and various parameters defining each player PL are recorded in the player data GD1 as an example. Such parameters include, for example, a name, an image, running force, kicking force, various physical features, and the like.

The storage unit 22 may appropriately store various data such as play data or ID data, for example, in addition to them. The play data is data in which information regarding a past play record of each user is described. The play data is used, for example, to take over the play result (past record) up to the previous time to a next time and thereafter or to take over a setting content unique to each user. For example, when each player PL of the soccer game grows according to the play situation, the information of the parameter corresponding to the growth may be managed as appropriate; and this is managed by the play data as the past record as an example. In this case, the parameter of each player PL is reproduced by a combination of the play data (change) and the player data GD1 (initial value). The ID data is data for managing various IDs. Such data includes a user ID for identifying each user. Since the play data is managed via the user ID, the user ID is used to generate or acquire the play data, for example. The play data, the ID data, and so on may be appropriately stored in the storage unit 22, but are provided from the server 3 so as to include a necessary part as an example.

Various output devices and input devices can be appropriately connected to the control unit 21, and the above-described controller 6 and monitor 7 are illustrated in the example in FIG. 6. The monitor 7 is a known display device for displaying various game screens for the soccer game such as the entire screen 50. The monitor 7 displays various game screens (images) for providing the soccer game according to the output signal from the control unit 21. Similarly, the controller 6 is a known input device provided with various operation units. The controller 6 outputs signals corresponding to various operations to each operation unit to the control unit 21.

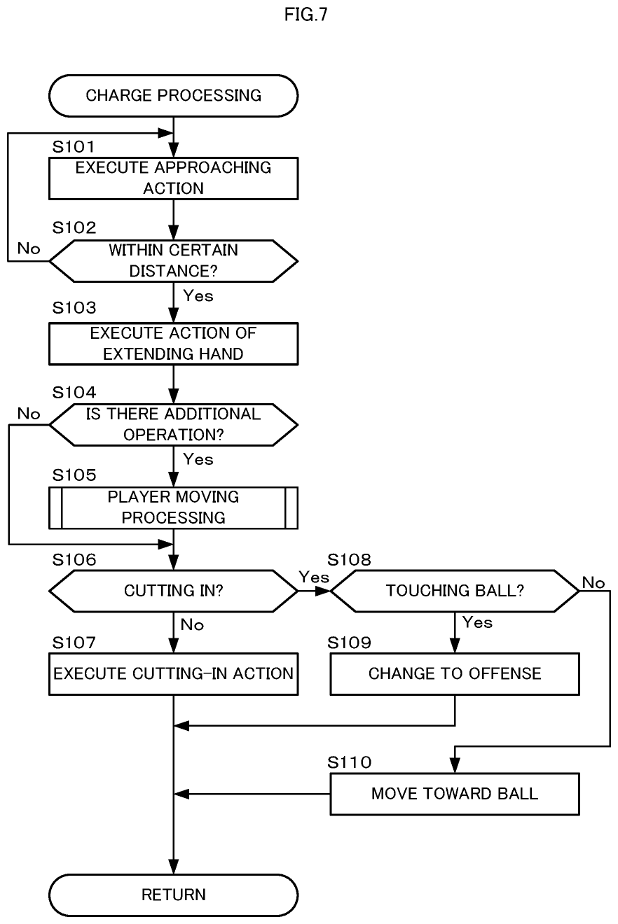

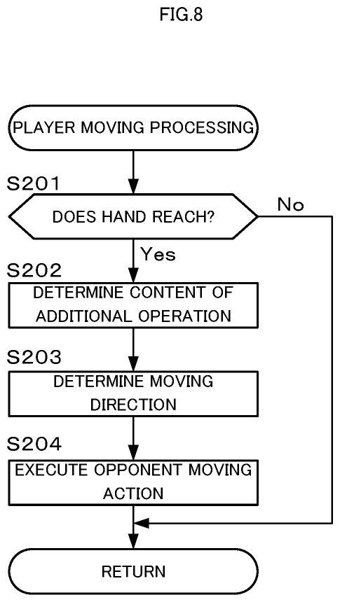

Next, the charge processing and player moving processing are described with reference to FIGS. 7 to 8. The charge processing is processing for implementing the charge action. When the L2 button 15L2 is continuously pressed for a predetermined time or longer, the display control unit 25 starts the charge processing in FIG. 7 and first causes the player PL on the defense side to execute an approaching action (step S101). Specifically, the display control unit 25 controls the display of the player PL on the defense side so as to execute an action of moving toward a predetermined position as the approaching action.

Subsequently, the display control unit 25 determines whether the player PL on the offense side is located within a certain distance from the player PL on the defense side, that is, whether the second reference position RP2 is included in the determination range DR (step S102). When the player PL on the offense side is not located within the certain distance from the player PL on the defense side (step S102: No), that is, when the second reference position RP2 is not included in the determination range DR, the display control unit 25 returns to step S101 and executes the processing at step S101 again so that the approaching action is continued.

In contrast, when the player PL on the offense side is located within the certain distance from the player PL on the defense side (step S102: Yes), that is, when the second reference position RP2 is included in the determination range DR, the display control unit 25 causes the player PL on the defense side to execute the action of extending the hand (step S103). Specifically, the display control unit 25 controls the display of the player PL on the defense side so as to start the action of extending the hand toward the player PL on the offense side.

Subsequently, the display control unit 25 determines whether the additional operation for indicating the opponent moving action is present, that is, whether the additional operation is executed (step S104). As an example of the additional operation, the operation on the L stick 14L is adopted as described above. Therefore, the display control unit 25 acquires an input result to the controller 6, and determines whether there is the operation on the L stick 14L as the presence or absence of the additional operation based on the input result.

When the additional operation is executed (step S104: Yes), that is, when the L stick 14L is operated, the display control unit 25 executes the player moving processing (step S105). The procedure of the player moving processing is described later in detail. In contrast, when the additional operation is not executed (step S104: No), that is, when the L stick 14L is not operated, or after the player moving processing at step S105, the display control unit 25 determines whether the player PL on the defense side cuts in between the ball BI and the player PL on the offense side (step S106).

When the player PL on the defense side does not cut in between the ball BI and the player PL on the offense side (step S106: No), the display control unit 25 causes the player PL on the defense side to execute the cutting-in action (step S107). That is, the display control unit 25 controls the display of the player PL on the defense side so as to execute the action of cutting in between the ball BI and the player PL on the offense side. Then, after the control (execution of the cutting-in action), the display control unit 25 ends the current charge processing. Incidentally, it may appropriately determine whether it is possible to actually cut in between the ball BI and the player PL on the offense side in accordance with the cutting-in action based on the parameter regarding ball keeping of the opponent or various situations such as whether the opponent executes an offense automatic action, for example.

In contrast, when the player PL on the defense side cuts in between the ball BI and the player PL on the offense side (step S106: No), the display control unit 25 determines whether the player PL on the defense side touches the ball BI (step S108). When the player PL on the defense side touches the ball BI (step S108: Yes), the display control unit 25 changes the player PL on the defense side to offense, that is, the player PL on the offense side (step S109). Then, after the change, the display control unit 25 ends the current charge processing.

Incidentally, the offense automatic action and the defense automatic action may be executed based on different operations, and as an example, not only the charge action but also the offense automatic action is associated with (assigned to) the operation of continuously pressing the L stick 14L. As such an action, an appropriate action may be adopted, and as an example, a shielding action is adopted. That is, the operation of pressing the L stick 14L continuously performed to execute the charge action directly functions as an indication of offense shielding action for after the player PL on the defense side touches (takes) the ball BI. Therefore, when taking the ball BI, the player PL on the defense side is switched to the player PL on the offense side, and the shielding action is directly started by the player PL on the offense side after the switching (change). The shielding action is an action for keeping control of the ball BI, and this is implemented as an action for guarding the ball BI by cutting in between the ball BI and the player PL on the defense side with the body, for example.

In contrast, when the player PL on the defense side does not touch the ball BI (step S108: No), the display control unit 25 moves the player PL on the defense side toward the ball BI as the action for taking the ball BI (step S110). That is, the display of the player PL on the defense side is controlled so as to execute the action of approaching the ball BI. Then, after the control (approaching action), the display control unit 25 ends the current charge processing. As a result, the charge action is implemented. Specifically, the charge action is implemented so that the approaching action, the action of extending the hand, and the cutting-in action are sequentially executed according to the distance to the player PL on the offense side.

The player moving processing is processing for implementing the opponent moving action. An example in FIG. 8 illustrates the player moving processing in a case where the opponent moving action is allowed (the special condition is satisfied) when the hand of the player PL on the defense side reaches the player PL on the offense side. In this case, when called at step S105 of the example in FIG. 7, the display control unit 25 starts the player moving processing in FIG. 8, and first determines whether the hand of the player PL on the defense side reaches the player PL on the offense side (step S201). When the hand of the player PL on the defense side does not reach the player PL on the offense side (step S201: No), the display control unit 25 skips the subsequent processing and ends the current player moving processing. Then, the display control unit 25 proceeds to step S106 in the charge processing of the example in FIG. 7.

In contrast, when the hand of the player PL on the defense side reaches the player PL on the offense side (step S201: Yes), the display control unit 25 determines the content of the additional operation (step S202). For example, when the moving direction TD of the opponent moving action changes according to the operation direction of the operation on the L stick 14L as described above, the display control unit 25 determines the operation direction of the operation on the L stick 14L as the content of the additional operation at step S202.

Subsequently, the display control unit 25 determines the moving direction TD in the opponent moving action, that is, the direction in which the player PL on the offense side should be moved based on a determination result at step S202 (step S203). The moving direction TD of the opponent moving action corresponds to the operation direction of the L stick 14L such as the right direction when the operation direction of the operation on the L stick 14L is the right direction as described above. Therefore, the display control unit 25 determines the operation direction of the L stick 14L as the moving direction TD of the opponent moving action.

Next, the display control unit 25 causes the player PL on the defense side to execute the opponent moving action reflecting the moving direction TD determined at step S203 (step S204). Specifically, the display control unit 25 controls the display of the player PL on the defense side so as to execute the opponent moving action of moving the player PL on the offense side in the moving direction TD determined at step S203. Then, after the control (opponent moving action), the display control unit 25 ends the current player moving processing. As a result, the opponent moving action is implemented. That is, the opponent moving action is added to the cutting-in action (charge action). More specifically, the opponent moving action reflecting the operation direction of the operation on the L stick 14L, that is, the opponent moving action of moving the player PL on the offense side in the moving direction TD corresponding to the operation direction of the L stick 14L is executed so as to be added to the cutting-in action.

As described above, according to the embodiment, when the operation on the L stick 14L is executed during the charge action by the automatic control, the operation is reflected in the action of the player PL on the defense side, and the player PL on the defense side executes the opponent moving action. Specifically, when the L stick 14L is operated at the contact distance (in a state in which the special condition is satisfied, that is, the hand of the player PL on the defense side reaches the player PL on the offense side), the charge action of the player PL on the defense side is controlled so as to execute the opponent moving action to move the player PL on the offense side in the operation direction of the operation. In contrast, when the L stick 14L is not operated, the charge action of the automatic control is continued. Therefore, using such an operation on the L stick 14L, it is possible to increase a room for a difference in skill between users to be reflected in the charge action of the automatic control. A similar cutting-in action is executed in actual soccer game, and in many cases, charge to bring the shoulder, hand, and the like into contact with the opponent for better positioning is performed. Therefore, it is possible to reproduce an action corresponding to such charge using the additional opponent moving action. As a result, not only the room for the difference in skill to be reflected is increased, but also the reality can be improved.

In the above-described embodiment, the display control unit 25 of the game device 2 functions as a result acquisition unit of the present invention by executing step S104 of the procedure in FIG. 7. The display control unit 25 of the game device 2 functions as an action control unit of the present invention by executing step S204 of the procedure in FIG. 8.

The present invention is not limited to the above-described embodiment, and may be implemented in an embodiment with appropriate modifications or changes. For example, in the above-described embodiment, the operation direction of 360° of the operation on the L stick 14L is used as the additional operation so as to be associated with the opponent moving operation in the moving direction TD of 360°. However, the present invention is not limited to such an embodiment. For example, only two types of the action of pulling and action of pushing the player PL on the offense side may be prepared as the opponent moving action, and the operation direction on the L stick 14L may be divided into two types according to an appropriate standard so as to correspond to each of the two types of opponent moving actions. The division of the two types may be implemented as appropriate, for example, such as two types of upper and lower sides based on a horizontal direction; and as an example, it is divided into two types of a travel direction side and an opposite direction side based on a direction orthogonal to a travel direction of the player PL on the defense side. In this case, the direction of the pushing action and the direction of the pulling action may be decided based on still another condition; as an example, the directions are decided in the travel direction in a case of the pushing action and in the opposite direction in a case of the pulling action. That is, two types of opponent moving actions of an operation of pushing in the travel direction and an action of pulling in the opposite direction may be executed according to two types of operations in the travel direction and the opposite direction.

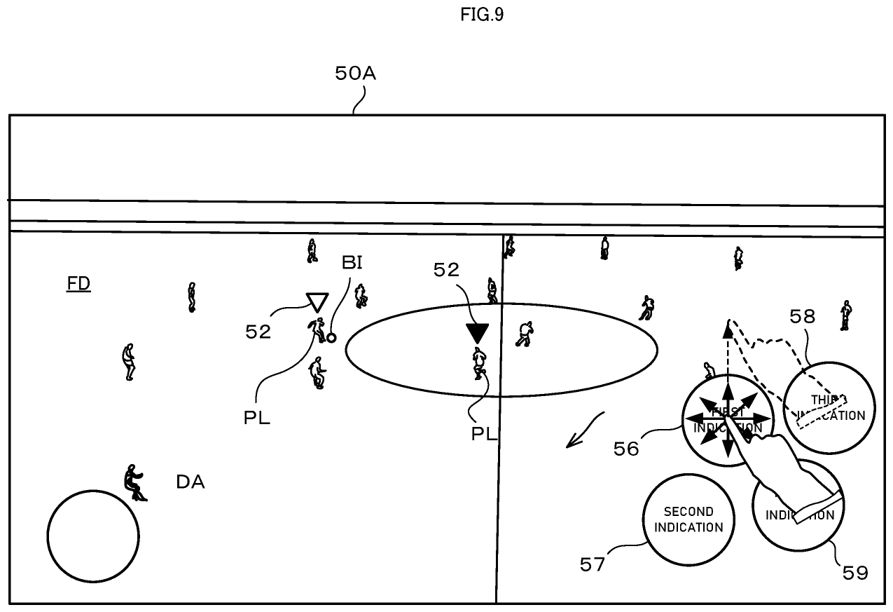

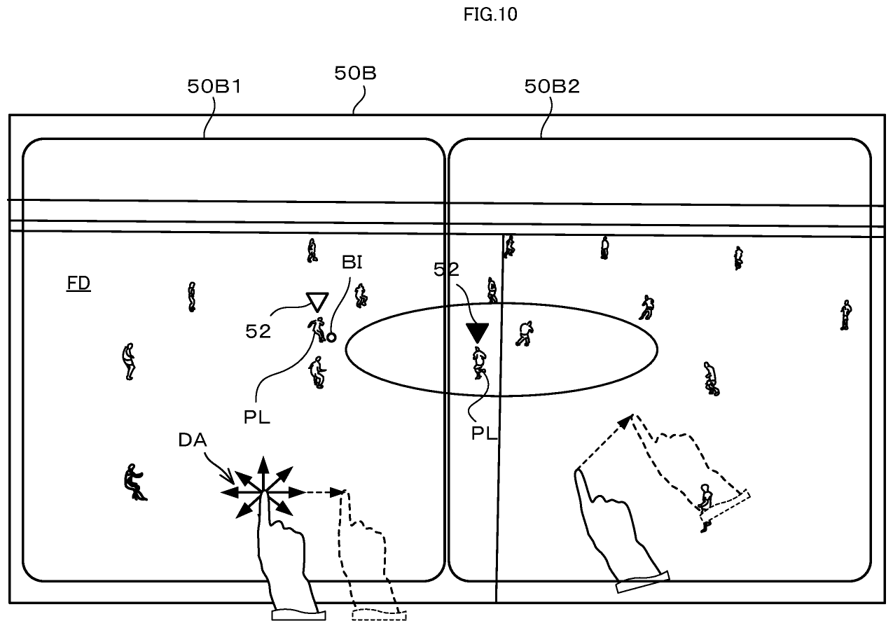

In the embodiment described above, the game device 2 is formed as a stationary game machine. However, the game device 2 of the present invention is not limited thereto, and may be various computer devices as described above. Then, various input devices that can be provided in such a game device 2 and various operations input thereto may be used as the input device and the additional operation of the present invention. FIGS. 9 and 10 are explanatory drawing for explaining an additional operation when a mobile phone (smartphone) is used and an additional operation when a portable game machine is used as the game device 2, respectively.

Specifically, the example in FIG. 9 illustrates a case where a touch panel of a mobile phone is used as an input device, and a touch operation on the touch panel is used as an additional operation. In the example in FIG. 9, a display of the mobile phone functions as the monitor 7, the CPU and so on provided in the mobile phone functions as the control unit 21 (computer), and the display and the touch panel of the mobile phone are connected to the control unit 21 inside the mobile phone. The example in FIG. 9 schematically illustrates an example of an entire screen 50A for a touch operation displayed on such a mobile phone. As illustrated in FIG. 9, four indication buttons from a first indication button 56 to a fourth indication button 59 are added in the entire screen 50A for touch operation as compared with the entire screen 50 in the example in FIG. 3. Incidentally, in the example in FIG. 9, display of the information portion 53 and the map 54 is omitted, but the entire screen 50A for touch operation may include them.

All of the four indication buttons from the first indication button 56 to the fourth indication button 59 are regions in which the touch operation for indicating an action (behavior) to the player PL should be executed. Various actions may be appropriately assigned to the first indication button 56 to the fourth indication button 59, and as an example, the charge action is assigned to the first indication button 56. Therefore, the first indication button 56 functions as an operation unit corresponding to the L2 button 15L2 of the controller 6. Furthermore, the first indication button 56 also functions as an operation unit for direction indication. Specifically, when the action of the player PL on the defense side is switched from the manual action to the charge action (automatic action) by continuing the touch operation on the first indication button 56, and a slide operation (operation of sliding while maintaining the touch operation) is executed in an appropriate direction directly on the first indication button 56, the opponent moving action is executed to move the player PL on the offense side in the direction of the slide operation. That is, the slide operation on the first indication button 56 functions as the additional operation, and the opponent moving action corresponding to the slide operation is executed. For this reason, for example, when the slide operation is executed upward, the opponent moving action of pushing the player PL on the offense side toward the far side is executed. Then, when the slide operations in eight directions indicated by the direction arrows DA are executed on the first indication button 56 similarly to the example in FIG. 5, each of them functions as the additional operation, and the opponent moving actions corresponding to the eight directions are implemented. Incidentally, the shielding action may be assigned to another indication button such as the second indication button 57, and is assigned to a double tap operation (an operation of continuously tapping twice) on the same first indication button 56 as an example. That is, unlike the case where the controller 6 is used as the input device, the shielding action is implemented by an operation different from the charge action.

An example in FIG. 10 illustrates a case where a touch operation different from that in the example in FIG. 9 on the touch panel is used as the additional operation. The example in FIG. 10 schematically illustrates an example of an entire screen 50B for a touch operation according to such variation. As illustrated in FIG. 10, the first indication button 56 to the fourth indication button 59 are omitted in the entire screen 50B for touch operation according to the variation as compared with the entire screen 50A for touch operation in the example in FIG. 9. Incidentally, in the example in FIG. 10 also, display of the information portion 53 and the map 54 is omitted as in the example in FIG. 9, but the entire screen 50B for touch operation may include them.

In contrast, in the entire screen 50B for the touch operation according to the variation, at least two regions including a region in which a direction indication should be executed and a region in which an action should be indicated are formed. Such two regions may be formed as appropriate, but in the example in FIG. 10, it is divided into two of a left screen 50B1 and a right screen 50B2 in the substantially central portion, and two regions are formed of the left screen 50B1 and the right screen 50B2. Incidentally, in the example in FIG. 10, boundary lines indicating the two regions of the left screen 50B1 and the right screen 50B2 are displayed for convenience of description, but display of such boundary lines may be omitted.

The left screen 50B1 is a region in which the touch operation for indicating the direction should be executed. The left screen 50B1 functions as an operation unit corresponding to the L stick 14L of the controller 6, and a similar indication regarding the direction is input. Specifically, the slide operation is allowed for any place on the left screen 50B1, and the slide operation for any place functions as the additional operation. In contrast, the right screen 50B2 is a region in which the touch operation for indicating an action (behavior) on the player PL should be executed. Specifically, an entire region of the right screen 50B2 functions similarly to the first indication button 56 in the example in FIG. 9, and the slide operation (regardless of direction) in any place functions as an indication of the charge action. Therefore, when the slide operation is executed in any place on the left screen 50B1 in a state in which the slide operation on the right screen 50B2 is maintained (in a state in which the touch operation is continued at an end point of the slide operation), the opponent moving action of moving the player PL on the offense side in the direction of the slide operation on the left screen 50B1 is executed. That is, the slide operation on the left screen 50B1 functions as the additional operation, and the opponent moving action corresponding to the slide operation is executed. Therefore, when the slide operations in eight directions indicated by the direction arrows DA are executed at any position of the left screen 50B1 similarly to the example in FIG. 5, each of them functions as the additional operation, and the opponent moving actions corresponding to the eight directions are implemented. Incidentally, as an example, the shielding action is implemented by a double tap operation to any position on the left screen 50B1. Therefore, the shielding action is also implemented by an operation different from the charge action.

In the embodiment described above, the game device 2 executes the processing in FIGS. 7 to 8. As a result, the single game device 2 (or the single control unit 21 of the game device 2) functions as the game system of the present invention. However, the present invention is not limited to such an embodiment. For example, the server 3 may execute an entire or a part of a role of the game device 2 (for example, the processing in FIGS. 7 to 8). For example, when the server 3 executes the entire processing in FIGS. 7 to 8, the single server 3 (including a case implemented by a combination of a plurality of server devices) may function as the game system of the present invention. Alternatively, on the contrary, the game device 2 may execute an entire or a part of the role of the server 3. In this case, the server 3 may be omitted.

Various aspects of the present invention derived from each of the above-described embodiment and variation are described below. Incidentally, in the following description, corresponding members illustrated in the accompanying drawings are added in parentheses to facilitate understanding of each aspect of the present invention, but the present invention is not limited to the illustrated embodiment.

The non-transitory computer readable storage medium of the present invention is a non-transitory computer readable storage medium storing a computer program for a computer (21) incorporated in a game system (5) connected to a display device (7) that displays a game screen (50) including an offense character (PL) and a defense character (PL) which play roles of offense and defense respectively, and an input device (6) that inputs a plurality of operations executed by a user as operations for operating the defense character in the game screen, and providing a game in which the defense character is automatically caused to execute a predetermined defense action according to a predetermined rule when a specific operation out of the plurality of operations is executed, wherein the computer program causes the computer to function as: a result acquisition unit (25) that acquires, when an input of an operation out of the plurality of operations is executed through the input device after a special condition related to a position between the defense character and the offense character is satisfied during the defense action, a result of the input; and an action control unit (25) that causes the defense character to execute an additional action so that the additional operation is reflected in an action of the defense character when the operation is determined to be an additional operation associated with the additional action that can be added to the defense action based on the result of the input.

According to the present invention, when the additional operation is executed after the special condition related to the position between the defense character and the offense character is satisfied during the defense action of automatic control, the additional operation is reflected in the action of the defense character, and the defense character executes the additional action. Therefore, using such an additional operation, it is possible to increase a room for a difference in skill between users to be reflected in the defense action of the automatic control.

The game system may appropriately provide various games including the offense character and the defense character. For example, the game system may provide an action game (sports game) such as a soccer game, a basketball game, or a boxing game. Then, the additional action may be an appropriate action that can be executed by the defense character in the various games. For example, in the basketball game, an action of extending a hand to a ball may be executed as the additional action while the defense action in which a defense player (defense character) moves while keeping a certain distance to an offense player (offense character) is being executed by the automatic control. The same applies to the soccer game. Alternatively, in the boxing game, an action of clinching while one player (defense character) is guarding against contiguous hits from the other player (offense character) by automatic control, or an action of throwing a punch may be executed as the additional action. In this manner, various actions according to the type of the game and so on may appropriately function as the additional actions. For example, in an aspect of the computer program of the present invention, the action control unit may cause the defense character to execute a moving action for moving the offense character in a predetermined direction as the additional action.

Furthermore, when the moving action is adopted as the additional action, a relative distance between the offense character and the defense character may change or may not change with the moving action. That is, the moving action may cause so that the distance between the offense character and the defense character increases or decreases, or cause so that the defense character moves together with the offense character so that the distance between the offense character and the defense character is maintained. Specifically, for example, in an aspect in which the moving action is executed as the additional action, the action control unit may cause the defense character to execute an action of changing a relative distance between the offense character and the defense character as the moving action.

The additional operation prepared in the game may be of one type or a plurality of types. For example, when one push button associated with a predetermined additional action is provided, an operation of pressing the push button may function as the additional operation, and the predetermined additional action may be executed when the push button is pressed. Alternatively, an operation of pressing one push button once and an operation of pressing the push button twice consecutively may be associated with different additional actions as different operations, and the additional action corresponding to the executed operation out of the operation of pressing once and the operation of pressing twice consecutively may be executed. Naturally, a plurality of push buttons may be provided, and operations of pressing the respective push buttons may be associated with different additional actions as different operations. The input device is not limited to have a configuration in which the pressing operation is input. For example, the input device may be provided with a direction indication type operation unit, and different additional operations may be associated with a plurality of directions that may be indicated to the operation unit, respectively. That is, the indications of different directions to the direction indication type operation unit may function as different types of additional operations. Alternatively, a detection device such as a camera that detects an action of the user may be used as the input device, and various actions such as an action of raising a right hand or an action of raising a left hand may function as different types of additional operations. That is, various devices capable of detecting a user's indication including an action (including an expression or eye motion) may function as the input device, and an appropriate operation according to the devices may be used as the additional operation.

Specifically, for example, in an aspect in which a moving action is executed as an additional action, the additional operation may include two or more additional operations corresponding to different directions, the moving action may include two or more moving actions associated with the two or more additional operations, and the action control unit may cause the defense character to execute a moving action corresponding to the additional operation so as to move the offense character in a direction corresponding to the additional operation according to executed additional operation out of the two or more additional operations. Furthermore, in this aspect, the plurality of operations may include a plurality of direction indication operations for indicating a plurality of directions, respectively, the plurality of direction indication operations may be used as the two or more additional operations, and the action control unit may cause the defense character to execute a moving operation corresponding to the direction indication operation so as to move the offense character in a direction corresponding to executed direction indication operation out of the plurality of direction indication operations.

The defense character and the offense character may be appropriate objects including various objects such as a vehicle or various animals such as a horse according to the game provided by the game system. Naturally, a human-shaped character may function as the defense character, for example. A special condition may be appropriately set according to a characteristic and so on, of the characters. For example, the special condition may be satisfied simply when a specific positional relationship (including a distance) is formed between the defense character and the offense character. Alternatively, the defense character and so on, may execute a predetermined action according to the positional relationship, and the special condition may be satisfied based on the action. For example, the defense character may execute an appropriate preliminary action for the additional action (including an action for notifying of the execution of the additional action) before executing the additional action, and the special condition may be satisfied when the preliminary action is executed. That is, presence or absence of the preliminary action (in a case of an action having a concept of start and completion, for example, it may be determined that there is the preliminary action when the action is completed) may be used as the special condition. Specifically, for example, in an aspect in which the moving action is executed as the additional action, a human-shaped character (PL) may be used as each of the defense character and the offense character, the defense action may include an action in which the defense character extends a hand toward the offense character within a certain distance between the defense character and the offense character, the special condition may be satisfied when the hand of the defense character reaches the offense character along with the action of extending the hand, and the action control unit may cause the defense character to execute an action of moving the offense character using the hand of the defense character as the moving action.

For example, in an aspect of the present invention, the game screen may include a ball (BI) that functions as a target for which the offense character and the defense character compete, and as the game, a soccer game may be provided in which two teams to which the offense character and the defense character belong, respectively, match against each other so that roles of offense and defense are switched according to presence or absence of the ball. Furthermore, in this aspect, the defense action may include a cutting-in action of moving the defense character to cut in between the offense character and the ball. In this case, it is possible to increase a room for a difference in skill between users to be reflected in the cutting-in action executed by automatic control in the soccer game. A similar cutting-in action is executed in actual soccer game, and in many cases, charge to bring a shoulder and a hand, for example, into contact with an opponent for better positioning is performed. Therefore, in particular, when a moving action is executed as an additional action in the soccer game, an action corresponding to such charge can be reproduced. As a result, not only the room for the difference in skill to be reflected is increased, but also the reality can be improved.

In contrast, the game system according to the present invention is a game system (5) comprising a computer (21) connected to a display device (7) that displays a game screen (50) including an offense character (PL) and a defense character (PL) which play roles of offense and defense respectively, and an input device (6) that inputs a plurality of operations executed by a user as operations to for operating the defense character in the game screen, and providing a game in which the defense character is automatically caused to execute a predetermined defense action according to a predetermined rule when a specific operation out of the plurality of operations is executed, wherein the computer serves as: a result acquisition unit (25) that acquires, when an input of an operation out of the plurality of operations is executed through the input device after a special condition related to a position between the defense character and the offense character is satisfied during the defense action, a result of the input; and an action control unit (25) that causes the defense character to execute an additional action so that the additional operation is reflected in an action of the defense character when the operation is determined to be an additional operation associated with the additional action that can be added to the defense action based on the result of the input.

The control method according to the present invention is a control method executed by a computer (21) incorporated in a game system (5) connected to a display device (7) that displays a game screen (50) including an offense character (PL) and a defense character (PL) which play roles of offense and defense respectively, and an input device (6) that inputs a plurality of operations executed by a user as operations for operating the defense character in the game screen, and providing a game in which the defense character is automatically caused to execute a predetermined defense action according to a predetermined rule when a specific operation out of the plurality of operations is executed, wherein the control method comprises: a result acquisition procedure of acquiring, when an input of an operation out of the plurality of operations is executed through the input device after a special condition related to a position between the defense character and the offense character is satisfied during the defense action, a result of the input, and an action control procedure of causing the defense character to execute an additional action so that the additional operation is reflected in an action of the defense character when the operation is determined to be an additional operation associated with the additional action that can be added to the defense action based on the result of the input. By executing the computer program or the control method of the present invention, the game system of the present invention can be implemented.

1. A non-transitory computer readable storage medium storing a computer program for a computer incorporated in a game system connected to a display device that displays a game screen including an offense character and a defense character which play roles of offense and defense respectively, and an input device that inputs a plurality of operations executed by a user as operations for operating the defense character in the game screen, and providing a game in which the defense character is automatically caused to execute a predetermined defense action according to a predetermined rule when a specific operation out of the plurality of operations is executed, wherein the computer program causes the computer to function as:
a result acquisition unit that acquires, when an input of an operation out of the plurality of operations is executed through the input device after a special condition related to a position between the defense character and the offense character is satisfied during the defense action, a result of the input; and
an action control unit that causes the defense character to execute an additional action so that the additional operation is reflected in an action of the defense character when the operation is determined to be an additional operation associated with the additional action that can be added to the defense action based on the result of the input.

2. The non-transitory computer readable storage medium storing the computer program according to claim 1, wherein the action control unit causes the defense character to execute a moving action for moving the offense character in a predetermined direction as the additional action.

3. The non-transitory computer readable storage medium storing the computer program according to claim 2, wherein the action control unit causes the defense character to execute an action of changing a relative distance between the offense character and the defense character as the moving action.

4. The non-transitory computer readable storage medium storing the computer program according to claim 2, wherein the additional operation includes two or more additional operations corresponding to different directions,
the moving action includes two or more moving actions associated with the two or more additional operations, and
the action control unit causes the defense character to execute a moving action corresponding to the additional operation so as to move the offense character in a direction corresponding to the additional operation according to executed additional operation out of the two or more additional operations.

5. The non-transitory computer readable storage medium storing the computer program according to claim 4, wherein the plurality of operations includes a plurality of direction indication operations for indicating a plurality of directions, respectively,
the plurality of direction indication operations are used as the two or more additional operations, and
the action control unit causes the defense character to execute a moving operation corresponding to the direction indication operation so as to move the offense character in a direction corresponding to executed direction indication operation out of the plurality of direction indication operations.

6. The non-transitory computer readable storage medium storing the computer program according to claim 2, wherein a human-shaped character is used as each of the defense character and the offense character,
the defense action includes an action in which the defense character extends a hand toward the offense character within a certain distance between the defense character and the offense character,
the special condition is satisfied when the hand of the defense character reaches the offense character along with the action of extending the hand, and
the action control unit causes the defense character to execute an action of moving the offense character using the hand of the defense character as the moving action.

7. The non-transitory computer readable storage medium storing the computer program according to claim 1, wherein the game screen includes a ball that functions as a target for which the offense character and the defense character compete, and
as the game, a soccer game is provided in which two teams to which the offense character and the defense character belong, respectively, match against each other so that roles of offense and defense are switched according to presence or absence of the ball.

8. The non-transitory computer readable storage medium storing the computer program according to claim 7, wherein the defense action includes a cutting-in action of moving the defense character to cut in between the offense character and the ball.

9. A game system comprising a computer connected to a display device that displays a game screen including an offense character and a defense character which play roles of offense and defense respectively, and an input device that inputs a plurality of operations executed by a user as operations to for operating the defense character in the game screen, and providing a game in which the defense character is automatically caused to execute a predetermined defense action according to a predetermined rule when a specific operation out of the plurality of operations is executed, wherein the computer serves as:
a result acquisition unit that acquires, when an input of an operation out of the plurality of operations is executed through the input device after a special condition related to a position between the defense character and the offense character is satisfied during the defense action, a result of the input; and
an action control unit that causes the defense character to execute an additional action so that the additional operation is reflected in an action of the defense character when the operation is determined to be an additional operation associated with the additional action that can be added to the defense action based on the result of the input.

10. A control method executed by a computer incorporated in a game system connected to a display device that displays a game screen including an offense character and a defense character which play roles of offense and defense respectively, and an input device that inputs a plurality of operations executed by a user as operations for operating the defense character in the game screen, and providing a game in which the defense character is automatically caused to execute a predetermined defense action according to a predetermined rule when a specific operation out of the plurality of operations is executed, wherein the control method comprises:
a result acquisition procedure of acquiring, when an input of an operation out of the plurality of operations is executed through the input device after a special condition related to a position between the defense character and the offense character is satisfied during the defense action, a result of the input, and
an action control procedure of causing the defense character to execute an additional action so that the additional operation is reflected in an action of the defense character when the operation is determined to be an additional operation associated with the additional action that can be added to the defense action based on the result of the input.
